(19) United States
(12) Patent Application Publication
(10) Pub. No.: US 2023/0001945 A1
(43) Pub. Date: Jan. 5, 2023

(54) ESTIMATION APPARATUS AND ESTIMATION METHOD

(71) Applicant: Panasonic Intellectual Property Management Co., Ltd., Osaka (JP)

(72) Inventors: Toru FUJISAWA, Kanagawa (JP); Takuma IIDA, Kanagawa (JP)

(73) Assignee: Panasonic Intellectual Property Management Co., Ltd., Osaka (JP)

(21) Appl. No.: 17/939,567

(22) Filed: Sep. 7, 2022

Related U.S. Application Data
(63) Continuation of application No. PCT/JP2020/045692, filed on Dec. 8, 2020.

(30) Foreign Application Priority Data
Mar. 12, 2020 (JP) 2020-043096

(51) Int. Cl. B60W 50/14; B60W 40/08; B60W 30/09

(52) U.S. Cl. CPC B60W 50/14; B60W 40/08; B60W 30/09; B60W 2050/146; B60W 2050/143

(57) ABSTRACT

An estimation apparatus of the disclosure includes a determiner that determines whether or not an attention target is visually recognizable from a driver of a vehicle based on information related to a visual field range of the driver; and an estimator that estimates a visual field abnormality of the driver based on a driving operation of the driver in a case where the determiner determines that the attention target is visually recognizable from the driver.

### TECHNICAL FIELD

The present disclosure relates to an estimation apparatus and estimation method.

### BACKGROUND ART

Conventional apparatuses that can estimate the visual field range of a driver of a vehicle are known. For example, Patent Literature (hereinafter, referred to as PTL) 1 discloses a configuration in which the visual field range of a driver during turning the vehicle to right at an intersection is estimated, and alerts the driver if there is a pedestrian or the like outside the visual field range.

### CITATION LIST

### Patent Literature

PTL 1

Japanese Patent Application Laid-Open No. 2012-14616

### SUMMARY OF INVENTION

### Technical Problem

With the increase in the elderly population in recent years, the proportion of elderly people in the driver population is also increasing year by year. Therefore, the proportion of drivers whose normal visual field range includes a range where the driver finds difficult to visually recognize objects (visual field abnormality) due to eye diseases caused by aging (for example, cataracts) may also increase.

However, such drivers may not be aware of their own visual field abnormality because they can lead a daily life without being aware of the visual field abnormality they have. Under the situation where the position of an attention target that the driver should pay attention to (for example, oncoming vehicle and pedestrian) changes every moment, there is an increased possibility during the driving operation by the driver that the driver's awareness of the approach of the attention target is delayed due to the visual field abnormality.

An object of the present disclosure is to provide an estimation apparatus and an estimation method both capable of accurately estimating the visual field abnormality of a driver.

### Solution to Problem

An estimation apparatus according to the present disclosure includes:

a determiner that determines whether or not an attention target is visually recognizable from a driver of a vehicle based on information related to a visual field range of the driver; and

an estimator that estimates a visual field abnormality of the driver based on a driving operation of the driver in a case where the determiner determines that the attention target is visually recognizable from the driver.

An estimation method according to the present disclosure is

an estimation method for estimating a visual field abnormality of a driver of a vehicle, the method including:

determining whether or not an attention target is visually recognizable from the driver based on information related to a visual field range of the driver; and

estimating the visual field abnormality of the driver based on a driving operation of the driver in a case where the attention target is determined to be visually recognizable from the driver.

### Advantageous Effects of Invention

The present disclosure enables accurate estimation of the visual field abnormality of a driver.

### BRIEF DESCRIPTION OF DRAWINGS

FIG. 1 is a block diagram illustrating an exemplary configuration of a vehicle to which a vehicle control unit according to an embodiment of the present disclosure is applied;

FIG. 2 is a diagram for explaining an exemplary relationship between a visual field range and an attention target;

FIG. 3 is a diagram for explaining an exemplary relationship between the visual field range and an attention target;

FIG. 4 is a diagram for explaining an exemplary relationship between the visual field range and an attention target;

FIG. 5 is a flowchart illustrating an exemplary operation of estimation control in the vehicle control unit;

FIG. 6 is a diagram for explaining an exemplary relationship between a visual field range divided into a plurality of regions and an attention target;

FIG. 7 is a diagram for explaining an exemplary relationship between the visual field range and an attention target at point A;

FIG. 8 is a diagram for explaining an exemplary relationship between the visual field range and an attention target at point B;

FIG. 9 is a diagram for explaining an exemplary adjustment of a visual field range;

FIG. 10 is a diagram for explaining an exemplary adjustment of a visual field range;

FIG. 11 is a block diagram illustrating an exemplary configuration of a vehicle including an authentication apparatus;

FIG. 12 is a block diagram illustrating an exemplary configuration of a vehicle including a safety apparatus;

FIG. 13 is a block diagram illustrating an exemplary configuration of a vehicle including a display output apparatus;

FIG. 14 illustrates an exemplary display output of the display output apparatus; and

FIG. 15 is a block diagram illustrating an exemplary configuration of a vehicle including a sound collection apparatus.

### DESCRIPTION OF EMBODIMENTS

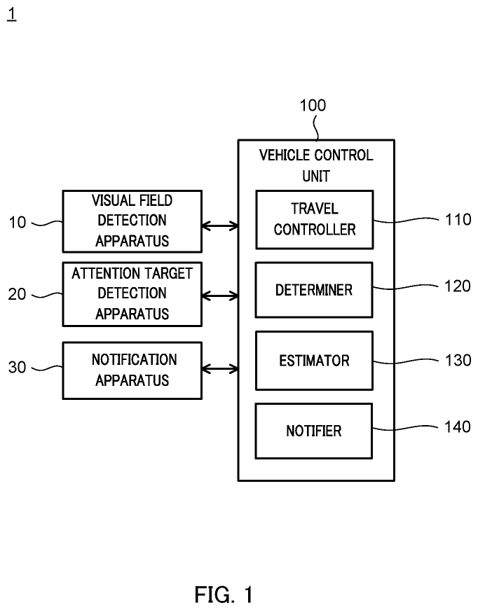

Hereinafter, at least one embodiment of the present disclosure will be described in detail with reference to the drawings. FIG. 1 is a block diagram illustrating an exemplary configuration of vehicle 1 to which an estimation apparatus according to an embodiment of the present disclosure is applied.

As illustrated in FIG. 1, vehicle 1 includes visual field detection apparatus 10, attention target detection apparatus 20, notification apparatus 30, and vehicle control unit 100.

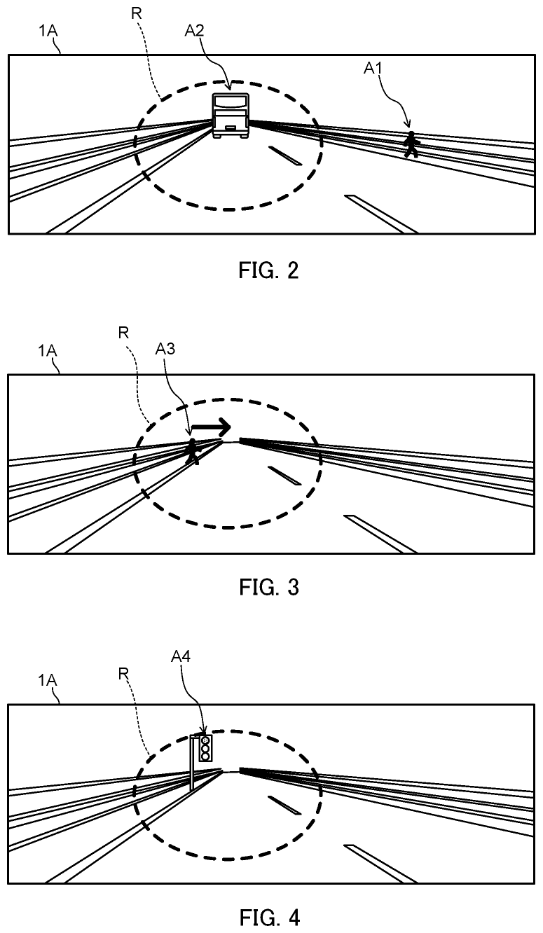

Visual field detection apparatus 10 is, for example, a driving monitor, and detects information on the visual field range of a driver. Visual field detection apparatus 10 detects information on the visual field range (for example, visual field range R illustrated in FIG. 2) of a driver by detecting the body motion of the driver during the driving. The visual line detection by visual field detection apparatus 10 can be performed by a known technique other than the above configuration.

Attention target detection apparatus 20 is, for example, a camera or a radar, and detects an attention target located around vehicle 1. The attention target is a target that the driver of vehicle 1 should pay attention to during the driving operation, and is, for example, at least one of a pedestrian, a bicycle, another vehicle, and a traffic light.

Notification apparatus 30 is an in-vehicle apparatus such as a car navigation device or an infotainment device, and notifies the driver of a visual field abnormality by performing display output or voice output based on a notification command from notification section (herein also referred to as “notifier”) 140 described below.

Vehicle control unit 100 includes a central processing unit (CPU), read only memory (ROM), random access memory (RAM), and input-output circuitry, which are not illustrated. Vehicle control unit 100 includes travel controller 110, determination section (herein also referred to as “determiner”) 120, estimation section (herein also referred to as “estimator”) 130, and notifier 140. Vehicle control unit 100 corresponds to an “estimation apparatus” of the present disclosure.

Travel controller 110 controls the travelling of vehicle 1 based on the information related to the driving operation of a driver. Examples of the driving operation of a driver include operations of gas pedal, brake pedal, and steering wheel, and other operations related to the driving operation of vehicle 1, as well as operations of other in-vehicle apparatuses such as a turn signal and a horn. Travel controller 110 corresponds to a “controller” of the present disclosure.

Determiner 120 determines whether or not an attention target is visually recognizable from a driver based on the information on the visual field range of the driver. The information on the visual field range corresponds to information on the visual field range of the driver detected by visual field detection apparatus 10. An attention target around vehicle 1 corresponds to information on the attention target detected by attention target detection apparatus 20.

“An attention target is visually recognizable from a driver” means that, for example, there is an attention target in the visual field range of the driver. “An attention target is not visually recognizable from a driver” means that, for example, there is no attention target in the visual field range of the driver.

When there is an attention target outside the visual field range of a driver, determiner 120 determines that the attention target is not visually recognizable from the driver. As illustrated in FIG. 2, for example, when pedestrian A1 located on the sidewalk in the opposite lane is outside visual field range R, determiner 120 determines that the attention target (i.e., pedestrian A1) is not visually recognizable from the driver. Drawings such as FIG. 2 illustrate windshield 1A as seen from the driver side.

Even in the case where determiner 120 determines that the attention target is not visually recognizable from a driver, the following case may occur: the attention target approaches visual field range R toward the inside of the range; or the attention target is located relatively close to vehicle 1 even when the location of the attention target is outside visual field range R. In this case, from the viewpoint of safe driving, vehicle control unit 100 performs the control of the traveling of vehicle 1 or the control related to alerting the driver by, for example, a known method.

In addition, when there is an attention target inside the visual field range of a driver, determiner 120 determines that the attention target is visually recognizable from the driver. For example, when another vehicle A2 located in front of vehicle 1 is inside visual field range R, the determiner determines that the attention target (i.e., another vehicle A2) is visually recognizable from the driver.

Estimator 130 estimates the visual field abnormality of a driver based on the driving operation of the driver in the case where determiner 120 determines that the attention target is visually recognizable from the driver. Specifically, when a driver does not perform a paying attention operation for an attention target (operation in which the driver pays attention to the attention target) within a predetermined time after the attention target is determined to be visually recognizable from the driver until the driver approaches the attention target, estimator 130 add this time to the number of times the paying attention operation is not performed. Estimator 130 determines whether or not the driver performs the paying attention operation based on the information—related to the driving operation—input to travel controller 110.

Examples of the paying attention operation include, when the attention target is a pedestrian, a bicycle, or another vehicle, driving operations for avoiding contact between vehicle 1 and the attention target, such as lowering the running speed of vehicle 1, stopping vehicle 1, slowing down vehicle 1, driving vehicle 1 so as to move away from the attention target, and honking a horn.

Examples of the paying attention operation include, when the attention target is a traffic light, driving operations related to safe driving of vehicle 1 according to traffic lights, such as stopping vehicle 1 when the traffic light displays the red light.

The predetermined time can be appropriately changed according to, for example, the type of attention target, the time during which the attention target is in the visual field range, the relative speed of vehicle 1 until the vehicle approaches the attention target, and the distance between the attention target and vehicle 1.

For example, when vehicle 1 is traveling while maintaining an appropriate inter-vehicle distance from another vehicle A2 located inside visual field range R, estimator 130 determines that the driver is performing the paying attention operation, and does not increase the number of times the paying attention operation is not performed.

In addition, as illustrated in FIG. 3, when vehicle 1 travels without lowering the running speed for a predetermined time after pedestrian A3, who is trying to cross in front of the vehicle, is determined to be visually recognizable from the driver, estimator 130 determines that the driver is not performing the paying attention operation, and adds this time to the number of times the paying attention operation is not performed.

In addition, as illustrated in FIG. 4, when vehicle 1 travels without lowering the running speed for a predetermined time after traffic light A4, which displays the red light, is determined to be visually recognizable from the driver, estimator 130 determines that the driver is not performing the paying attention operation, and adds this time to the number of times the paying attention operation is not performed.

Then, estimator 130 estimates the visual field abnormality according to the number of times where driver does not perform paying attention operation. When the number of times the driver does not perform the paying attention operation reaches a predetermined number of times, estimator 130 estimates that the driver has a visual field abnormality. At the predetermined number of times, the possibility of visual field abnormality can be determined to be relatively high. The predetermined number of times can be appropriately set according to the age of the user (for example, a driver), information related to the user's visual field abnormality (for example, diagnosis result from hospital), traveling time of vehicle 1, and the like.

This configuration enables accurate estimation of the visual field abnormality of a driver.

Notifier 140 outputs a notification command for notifying the driver of the visual field abnormality to notification apparatus 30 according to the number of times the driver does not perform the paying attention operation. When the notification command is input, notification apparatus 30 outputs a voice or a display such as “You may have a tendency for visual field abnormality” or “Please consider to have a check-up for visual field abnormality” to the driver to notify the visual field abnormality.

This configuration can inform drivers of the presence or absence of visual field abnormality, thereby allowing the drivers to recognize their visual field abnormality.

In the case where determiner 120 determines that an attention target is visually recognizable from a driver, notifier 140 outputs, to notification apparatus 30, a command related to alerting a driver who is estimated to have a visual field abnormality. When the command is input, notification apparatus 30 alerts the driver by outputting a voice or a display such as “Please pay attention to the attention target in front of the vehicle.” Notifier 140 corresponds to an “alerter” of the present disclosure.

This configuration allows the driver, who is estimated to have a visual field abnormality, to notice the attention target more easily.

Travel controller 110 controls the travelling of vehicle 1 according to the inputting of information related to the driving operation after an attention target is determined to be visually recognizable from the driver. For example, travel controller 110 performs travel control such as lowering the running speed of vehicle 1 if there is no such inputting even after the above-described predetermined time has passed.

This configuration can ensure the safety function in vehicle 1 even when the driver does not notice the attention target.

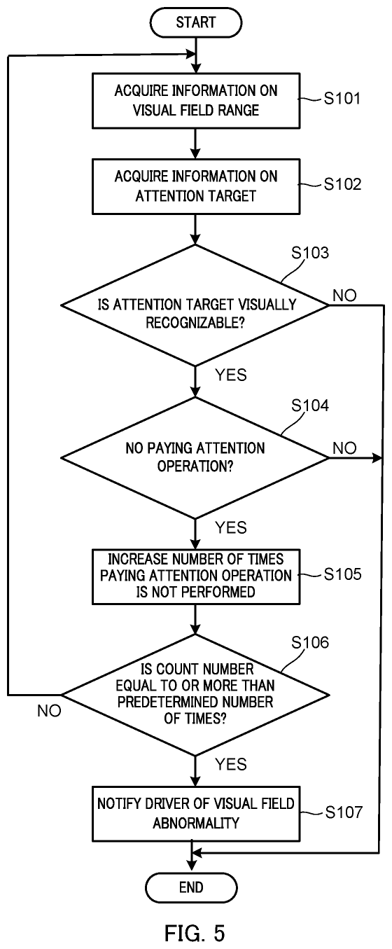

An exemplary operation of estimation control in vehicle control unit 100 configured as described above will be described. FIG. 5 is a flowchart illustrating an exemplary operation of estimation control in vehicle control unit 100. The processing in FIG. 5 is appropriately performed, for example, when the vehicle starts traveling.

As illustrated in FIG. 5, vehicle control unit 100 acquires the information on a visual field range (step S101). After acquiring the information on the visual field range, vehicle control unit 100 acquires the information on an attention target (step S102).

Vehicle control unit 100 then determines whether or not the attention target is visually recognizable from a driver (step S103). When the vehicle control unit determines that the attention target is not visually recognizable (step S103, NO), this control ends. In this case, control based on the viewpoint of safe driving is performed separately as necessary.

On the other hand, when the attention target is visually recognizable (step S103, YES), vehicle control unit 100 determines whether there is no paying attention operation by the driver for the attention target (step S104).

When the vehicle control unit determines that there is a paying attention operation by the driver (step S104, NO), this control ends. In this case, control based on the viewpoint of safe driving is performed separately as necessary.

On the other hand, when there is no paying attention operation by the driver (step S104, YES), vehicle control unit 100 adds this time to (increases) the number of times (count number) the driver does not perform the paying attention operation (step S105).

Vehicle control unit 100 then determines whether or not the count number is equal to or more than a predetermined number of times (step S106). When the vehicle control unit determines that the count number is less than the predetermined number of times (step S106, NO), the processing returns to step S101. When there is no change in visual field range, the processing may return to step S102.

On the other hand, when the count number is equal to or more than the predetermined number (step S106, YES), vehicle control unit 100 notifies the driver of the visual field abnormality (step S107). After step S107, this control ends.

The present embodiment configured as described above estimates the visual field abnormality of a driver based on the driver's driving operation. Specifically, the visual field abnormality of a driver is estimated according to the number of times the paying attention operation for an attention target is not performed after the attention target is determined to be visually recognizable from the driver until a predetermined time passes. As a result, the presence or absence of the visual field abnormality can be estimated at a timing where the possibility of the visual field abnormality can be determined to be high to some extent, thereby enabling accurate estimation of the visual field abnormality of a driver.

In addition, the drivers are notified of the visual field abnormality, and thus the drivers can recognize that they has the visual field abnormality. The driver therefore can focus on more careful driving, and urging the driver to go to the hospital for visual field abnormality is also possible.

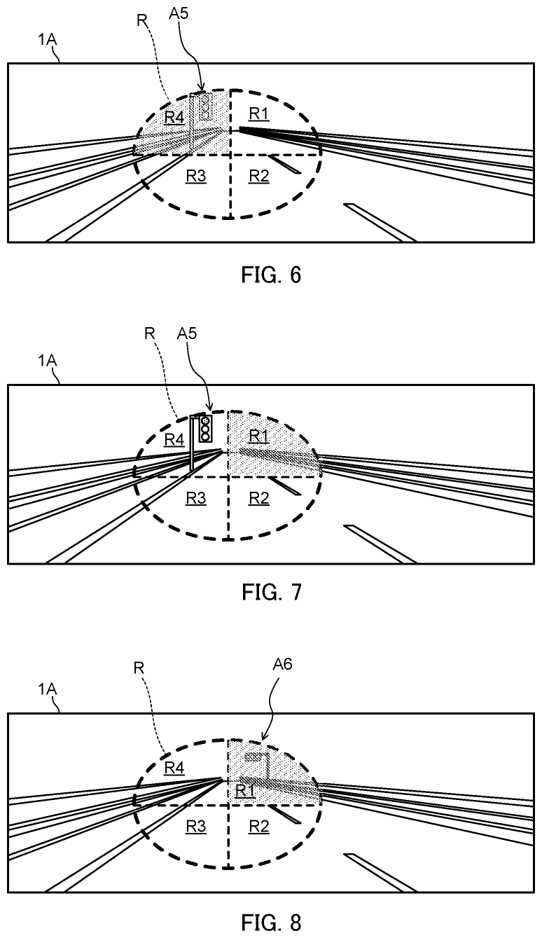

In the above embodiment, the visual field abnormality is estimated for the entire visual field range; however, there are some drivers who have difficulty in seeing only in a specific part in the visual field range. Therefore, estimator 130 may divide visual field range R into a plurality of regions as illustrated in FIG. 6. Estimator 130 then may count the number of times the paying attention operation for an attention target is not performed in each region, and may estimate the visual field abnormality for each region.

The plurality of regions include first region R1, which is an upper right region with respect to the center of visual field range R, second region R2, which is a lower right region with respect to the center, third region R3, which is a lower left region with respect to the center, and fourth region R4, which is an upper left region with respect to the center.

For example, when the number of times the paying attention operation is not performed for an attention target (for example, traffic light A5) in fourth region R4 is significantly higher than that in the other regions, estimator 130 estimates that the driver has a visual field abnormality in fourth region R4, and estimates that the driver has no visual field abnormality in the other regions.

This configuration allows the identification of a region where a driver particularly difficult to see, thereby enabling accurate estimation of the visual field abnormality of the driver.

In addition, estimating a visual field abnormality for each region in this manner allows, for example, notifier 140 to output the command related to the alerting as describe above only for the region where the driver has the visual field abnormality. As a result, it is possible to improve the accuracy of alerting for a region where the driver has the visual field abnormality.

In addition, in the above embodiment, the number of times the paying attention operation is not performed is counted every time vehicle 1 travels; however, some drivers often follow the same traveling route. For example, it is assumed that traffic light A5 is located on the left side (fourth region R4) at point A (see FIG. 7) and traffic light A6 is located on the right side (first region R1) at point B on the traveling route (see FIG. 8).

For such a route, in the case of a driver who is still not estimated to have a visual field abnormality by estimator 130 but the number of times the paying attention operation is not performed increases in the region on the right side, the following may occur: the number of times the paying attention operation is not performed for traffic light A5 is almost zero at point A, whereas the number of times the paying attention operation is not performed for traffic light A6 increases at point B. In other words, in the case of a driver who often follows the same traveling route, the increase of this number of times at point B may be used to determine at an early stage that the driver has a visual field abnormality in the right region (for example, first region R1).

For this purpose, estimator 130 adjusts the estimation result of the visual field abnormality based on the traveling route of vehicle 1 for the driver.

The information on a traveling route can be obtained, for example, from map information stored in a storage section (not illustrated) mounted on the vehicle, or vehicle position information from a car navigation device or a global positioning system (GPS) module.

For example, estimator 130 weights the count number (the number of times the paying attention operation is not performed) when vehicle 1 travels on the same traveling route. Specifically, for example, when the paying attention operation is not performed for the attention target at point B, estimator 130 doubles the number to be added. This configuration enables estimation of the visual field abnormality at an early stage based on the position of an attention target, for which the driver does not perform the paying attention operation, at the same point.

In addition, for some drivers, how easily the driver can see may change within the visual field range depending on the weather condition and the driving time zone. The information on the weather condition and the time zone can be obtained from, for example, a car navigation device or the like.

For example, the following case is assumed: a driver has difficulty in seeing the region on the right side of the visual field range when the weather condition is cloudy. In the case of the driver who has a visual field abnormality in the right region, the following may occur: when the weather condition is sunny, the number of times the paying attention operation is not performed is almost zero, whereas when the weather condition is cloudy, the number of times the paying attention operation is not performed for the attention target in the region on the right side of the visual field range increases. In other words, in the case of the driver who has difficulty in seeing the region on the right side of the visual field range when the weather condition is cloudy, the increase of this number of times when the weather condition is cloudy may be used to determine at an early stage that the driver has a visual field abnormality in the right region.

For this purpose, estimator 130 adjusts the estimation result of the visual field abnormality based on the traveling environment of vehicle 1. For example, estimator 130 weights the count number when the weather condition is cloudy. Specifically, when the paying attention operation is not performed for the attention target in the region on the right side of the visual field range under the cloudy weather condition, the number to be added is doubled. This configuration enables estimation of the visual field abnormality at an early stage based on changes in the traveling environment.

In addition, for example, when the time zone is near the evening, a driver may find difficult to see the front due to afternoon sunlight slanted through the window. In this case, even when there is an attention target in the visual field range, the attention target may become difficult for the driver to see. Even though there is no visual field abnormality, this case may be mistakenly estimated as a visual field abnormality.

Therefore, in this case, estimator 130 does not add this time even when the driver does not perform a paying attention operation for the attention target. This configuration can improve the estimation accuracy of the visual field abnormality.

In addition, in the above embodiment, the estimation result of the visual field abnormality may be adjusted according to the driving time of a driver. As the driving time increases, the number of times (count number) determined such that the paying attention operation is not performed also increases accordingly. The count number include the times that are not caused by a visual field abnormality, but caused by, for example, a mere carelessness; therefore, when the count number increases as the driving time increases, the number may exceed the threshold value for determining the visual field abnormality. Then, estimator 130 may estimate that the visual field is abnormal even if that is not the case.

Therefore, estimator 130 adjusts the estimation result of the visual field abnormality according to the driving time of a driver.

For example, estimator 130 reduces the count number by one when the driving time by a driver reaches a predetermined driving time. This configuration can prevent estimation of a visual field abnormality mistakenly made because of the increased driving time, thereby improving the estimation accuracy of the visual field abnormality.

Such a count number would increase simply as the driver's visual field abnormality progresses. Estimator 130 thus may determine whether or not to reduce the count number based on the increase rate or the like in the count number for each predetermined driving time. Specifically, estimator 130 determines that the visual field abnormality may be progressing, thus determines not to reduce the count number in the following case: when the increase rate in the count number in the latest first predetermined driving time is equal to or higher than the increase rate in the count number in the previous second predetermined driving time.

In addition, estimator 130 may adjust the estimation result of the visual field abnormality according to map information. The map information is stored in a storage section (not illustrated) mounted on the vehicle or obtained from the outside.

The number of traffic lights changes depending on the area where vehicle 1 travels (for example, in the city or the countryside). Thus, the frequency of the increase of the count number inevitably decreases in the area where the number of traffic lights is small. Therefore, for some drivers having a visual field abnormality, the timing that the driver is estimated to have a visual field abnormality may be delayed.

Therefore, estimator 130 adjusts the estimation result of the visual field abnormality according to map information. For example, estimator 130 doubles the number to be added in the area where the number of traffic lights is small. This configuration can prevent estimation that the driver has a visual field abnormality from being delayed depending on the area where vehicle 1 travels.

No mention is made of data of vehicle 1 in the above embodiment, but the following can be, for example, considered. The visual field range changes between a large vehicle and a small vehicle as the driver's view changes depending on the size of the vehicle. When the data of a visual field range obtained for a medium-sized vehicle is applied to a large or small vehicle, the direction of the driver's visual line changes and the visual field range related to the data may deviate from the actual visual field range of the driver.

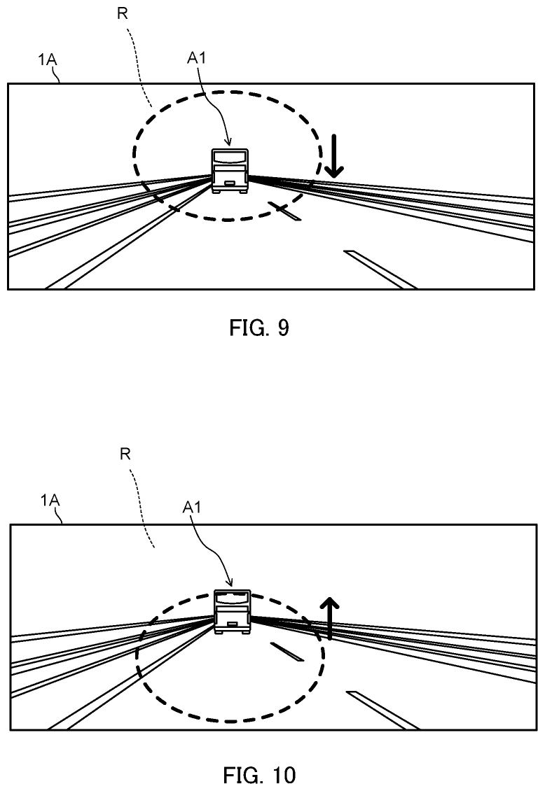

Therefore, determiner 120 may adjust the visual field range based on the data of vehicle 1. For example, in a large vehicle, the driver's visual line is lower than that of a medium-sized vehicle, and thus determiner 120 shifts visual field range R downward to perform a determination as illustrated in FIG. 9.

In addition, in a small vehicle, the driver's visual line is higher than that of a medium-sized vehicle, and thus determiner 120 shifts visual field range R upward to perform a determination as illustrated in FIG. 10.

This configuration can prevent estimation of a visual field abnormality mistakenly made because of the deviation of a visual field range due to the type of vehicle 1, thereby improving the estimation accuracy of the visual field abnormality.

In the above description, it is assumed that the drivers were the same. However, the visual field range changes depending on who drives the vehicle, and a region where each driver particularly difficult to see also changes. In vehicle 1 driven by a plurality of drivers, it is thus necessary to distinguish the visual field ranges from each other for different drivers, as well as the numbers of times the paying attention operation is not performed.

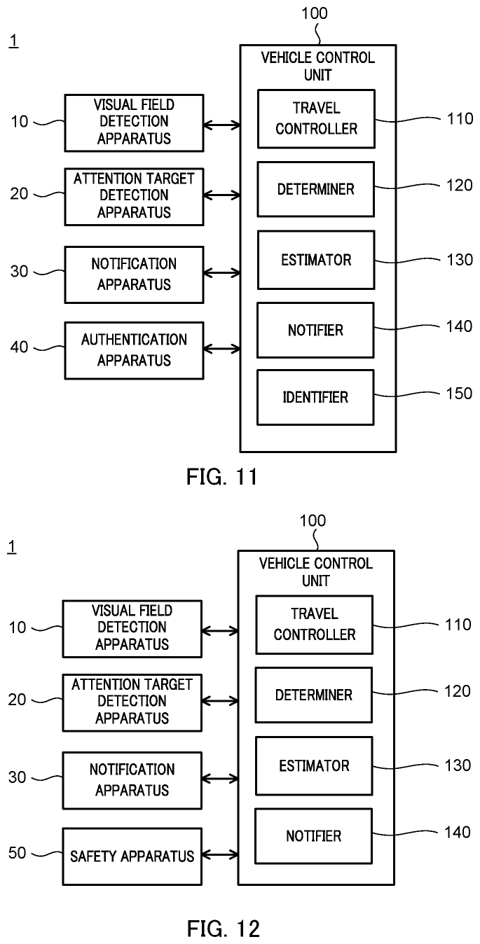

For this purpose, as illustrated in FIG. 11, vehicle control unit 100 includes identification section (herein also referred to as “identifier”) 150 in addition to the configuration illustrated in FIG. 1. Identifier 150 acquires the information on drivers from authentication apparatus 40 provided in vehicle 1. Authentication apparatus 40 is, for example, a driving monitor, which is capable of authenticating a driver. Authentication apparatus 40 may authenticate a driver by face authentication, or may authenticate the driver based on the driver information input by the driver.

Identifier 150 identifies a driver based on the information on the driver. Estimator 130 estimates the visual field range of the driver based on the identified result from identifier 150. Information corresponding to the driver to be identified by identifier 150, namely the visual field range and the number of times the paying attention operation is not performed, is stored in the storage section or the like.

This configuration can prevent estimation of a visual field abnormality mistakenly made because of the change of the driver, thereby improving the estimation accuracy of the visual field abnormality.

In the above embodiment, travel controller 110 performed the travel control to ensure the safety function. Alternatively, as illustrated in FIG. 12, safety apparatus 50 provided in vehicle 1 may be used for the function. A known apparatus, such as an automatic brake, can be used as safety apparatus 50.

Travel controller 110 may perform the control such that an operation command for safety apparatus 50 is output when a driver estimated to have a visual field abnormality drives vehicle 1. Travel controller 110 corresponds to the “operation commander” of the present disclosure.

This configuration can ensure the safety function in vehicle 1 even when a driver estimated to have a visual field abnormality drives vehicle 1.

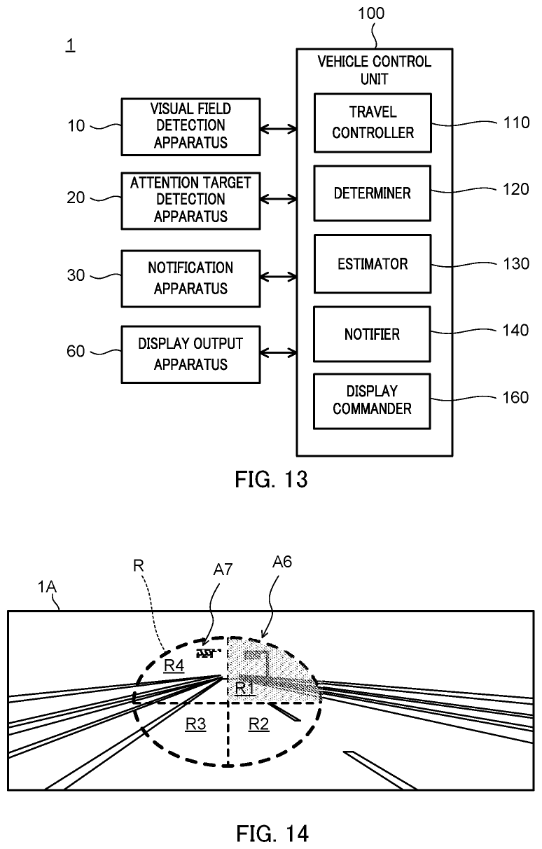

Vehicle control unit 100 may include display command section (herein also referred to as “display commander”) 160 in addition to the configuration illustrated in FIG. 1 in the following case: vehicle 1 includes display output apparatus 60, such as a head-up display apparatus that displays a predetermined image on a display medium, such as windshield 1A, as illustrated in FIG. 13.

Display commander 160 outputs a display command to display output apparatus 60 for displaying an image—related to an attention target in a region of the visual field range where a driver has the visual field abnormality—in a region of the visual field range where the driver has no visual field abnormality. As illustrated in FIG. 14, when, for example, a driver has a visual field abnormality in first region R1 of visual field range R, display commander 160 outputs a display command to display output apparatus 60. Here, the display command is for displaying image A7—related to traffic light A6 located in first region R1—in fourth region R4 where the driver has no visual field abnormality.

When display output apparatus 60 acquires the display command, display output apparatus 60 displays a display based on the display command in fourth region R4 of visual field range R on windshield 1A. Image A7 in FIG. 14 is an image showing traffic light A6 itself. Alternatively, the image output by display output apparatus 60 may be any image, such as characters and other images, as long as a driver can understand an attention target located in the region of the visual field abnormality. The display medium may be a side mirror or a rear-view mirror in place of a windshield, or two or more of the windshield, side mirrors, and rear-view mirror.

This configuration allows a driver having a visual field abnormality to check an attention target that the driver cannot see, thereby contributing to the safe driving of vehicle 1.

In addition, a driver who has a hearing abnormality in addition to a visual field abnormality may not be able to recognize the sound of a horn from another vehicle outside vehicle 1, voice guidance inside vehicle 1, or the like.

Therefore, estimator 130 may estimate the degree of hearing abnormality of a driver according to the reaction of the driver to the sound generated around the driver.

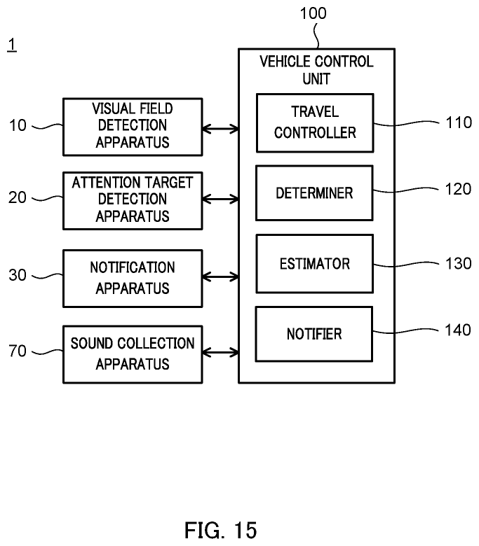

As illustrated in FIG. 15, for example, the sound generated around a driver is collected by sound collection apparatus 70, such as a microphone provided in vehicle 1. Estimator 130 counts the number of times the driver does not perform the paying attention operation to the sound collected by sound collection apparatus 70, and estimates the degree of hearing abnormality of the driver according to the number of times.

This configuration can estimate the degree of hearing abnormality in addition to visual field abnormality.

The above configurations (modes illustrated in FIGS. 1, 11, 12, 13, and 15) can be appropriately combined and configured as necessary.

In the above embodiment, the presence or absence of the visual field abnormality is estimated, but the present disclosure is not limited thereto. Visual field abnormalities may be estimated by level. For example, estimator 130 estimates visual field abnormalities by level, such as mild, moderate, and severe, as the number of times the paying attention operation is not performed increases.

This configuration can estimate a visual field abnormality in detail.

In the above embodiment, a visual field abnormality is estimated according to the number of times the paying attention operation is not performed, but the present disclosure is not limited thereto. For example, the visual field abnormality may be estimated based on the number of times of another driving operation caused by the delay in noticing an attention target, such as sudden braking or abrupt steering.

In addition, estimator 130 may score the number of times the driver does not perform the paying attention operation according to the timing at which the driver performs the paying attention operation, thereby estimating a visual field abnormality according to the points obtained by the scoring.

For example, it is assumed that the paying attention operation performed by a driver is deceleration of vehicle 1 by pushing the brake pedal. For example, the score is set to 0 point when the driver decelerates vehicle 1 at a predetermined deceleration position, and the score is set to increase as the number of seconds after passing the predetermined deceleration position increases. The score is assumed to be set to 5 points (highest score) when the paying attention operation is not performed at all, such as crossing the attention target without decelerating vehicle 1.

The predetermined deceleration position is determined according to the initial speed and the average deceleration rate of vehicle 1, and is set to, for example, a position where safety is sufficiently ensured. In addition, the predetermined deceleration position may be determined by any one of various methods, such as a known method.

Estimator 130 accumulates the points obtained by the scoring, and estimates that the visual field is abnormal when the accumulated score reaches a predetermined value or more. At the predetermined value, the possibility of visual field abnormality can be determined to be relatively high. The predetermined value can be appropriately set according to the age of the user (for example, a driver), information related to the user's visual field abnormality (for example, diagnosis result from hospital), traveling time of vehicle 1, and the like.

This configuration can weight the behavior of a driver not performing a paying attention operation, thus can estimate the visual field abnormality by smaller levels.

In the above embodiment, the driver is alerted by a command from notifier 140 to notification apparatus 30, but the present disclosure is not limited thereto. For example, any apparatus, such as a vibration device that transmits vibration to the driver, or a blower device that blows air to the driver, may be used to alert the driver as long as the driver can understand that he or she is alerted.

In the above embodiment, a visual field abnormality is estimated based on the number of times the driver does not perform the paying attention operation, but the present disclosure is not limited thereto. The visual field abnormality may be estimated based on a parameter obtained from the number of times the driver does not perform the paying attention. An example of the parameter is the ratio of the number of times the driver does not perform the paying attention to the total number of times at which it is determined that the attention target is visually recognizable in the visual field range.

In the above embodiment, the estimation apparatus (vehicle control unit) is provided with a notifier, but the present disclosure is not limited thereto. It is possible not to provide the notifier.

In the above embodiment, the estimation apparatus is provided with a travel controller; however, when the estimation apparatus is not incorporated in the vehicle control unit, it is possible not to provide a travel controller in the estimation apparatus.

In the above embodiment, the travel controller, determiner, estimator, and notifier are incorporated in the vehicle control unit, but the present disclosure is not limited thereto. A configuration in which the travel controller, determiner, estimator, and notifier are provided separately is also possible.

The embodiments above are no more than specific examples in carrying out the present disclosure, and the technical scope of the present disclosure is not to be construed in a limitative sense due to the specific examples. That is, the present disclosure can be carried out in various forms without departing from the spirit and the main features thereof.

### Industrial Applicability

This application is entitled to and claims the benefit of Japanese Patent Application No. 2020-043096 filed on Mar. 12, 2020, the disclosure of which including the specification, drawings, and abstract is incorporated herein by reference in its entirety.

An estimation apparatus of the present disclosure is particularly advantageous as an estimation apparatus and for an estimation method both capable of accurately estimating the visual field abnormality of a driver.

### Reference Signs List

1 Vehicle
10 Visual field detection apparatus
20 Attention target detection apparatus
30 Notification apparatus
40 Authentication apparatus
50 Safety apparatus
60 Display output apparatus
70 Sound collection apparatus
100 Vehicle control unit
110 Travel controller
120 Determiner
130 Estimator
140 Notifier
150 Identifier
160 Display commander

1. An estimation apparatus, comprising:
a determiner that determines whether or not an attention target is visually recognizable from a driver of a vehicle based on information related to a visual field range of the driver; and
an estimator that estimates a visual field abnormality of the driver based on a driving operation of the driver in a case where the determiner determines that the attention target is visually recognizable from the driver.

2. The estimation apparatus according to claim 1, wherein:
the estimator estimates the visual field abnormality according to the number of times a paying attention operation is not performed for the attention target by the driver after the attention target is determined to be visually recognizable from the driver.

3. The estimation apparatus according to claim 2, wherein:
the estimator performs scoring of the number of times the paying attention operation is not performed, and estimating of the visual field abnormality according to a point obtained by the scoring, the estimator performing the scoring according to a timing at which the paying attention operation is performed by the driver.

4. The estimation apparatus according to claim 1, further comprising:
a notifier that notifies the driver of the visual field abnormality.

5. The estimation apparatus according to claim 1, wherein:
the attention target is at least one of a pedestrian, a bicycle, another vehicle, and a traffic light.

6. The estimation apparatus according to claim 1, further comprising:
a controller that controls the vehicle based on the driving operation of the driver, wherein
the estimator estimates the visual field abnormality based on information input to the controller, the information being related to the driving operation.

7. The estimation apparatus according to claim 6, wherein:
the controller controls an operation of the vehicle according to inputting of the information related to the driving operation, the inputting being performed after the attention target is determined to be visually recognizable from the driver.

8. The estimation apparatus according to claim 1, further comprising:
an alerter that alerts the driver when the attention target is present in a part with the visual field abnormality in the visual field range.

9. The estimation apparatus according to claim 1, wherein:
the estimator adjusts an estimation result of the visual field abnormality based on at least one of a traveling route of the vehicle for the driver and a traveling environment of the vehicle.

10. The estimation apparatus according to claim 1, wherein:
the estimator adjusts an estimation result of the visual field abnormality according to a driving time of the driver.

11. The estimation apparatus according to claim 1, wherein:
the estimator adjusts an estimation result of the visual field abnormality according to map information.

12. The estimation apparatus according to claim 1, wherein:
the determiner adjusts the visual field range based on data of the vehicle.

13. The estimation apparatus according to claim 1, further comprising:
an identifier that identifies the driver, wherein
the estimator estimates the visual field abnormality based on an identified result from the identifier.

14. The estimation apparatus according to claim 1, further comprising:
an operation commander that outputs an operation command for an safety apparatus of the vehicle based on an estimation result of the visual field abnormality.

15. The estimation apparatus according to claim 1, further comprising:
a display commander that outputs a display command to a display output section that displays a predetermined image on a display medium, wherein
the display commander outputs, to the display output section, the display command for displaying the attention target in a part without the visual field abnormality in the visual field range, the attention target being present in a part with the visual field abnormality in the visual field range.

16. The estimation apparatus according to claim 15, wherein:
the display medium is at least one of a windshield, a side mirror, and a rear-view mirror of the vehicle.

17. The estimation apparatus according to claim 1, wherein:
the estimator estimates a degree of hearing abnormality of the driver according to a reaction of the driver to sound generated around the driver.

18. An estimation method for estimating a visual field abnormality of a driver of a vehicle, the method comprising:
determining whether or not an attention target is visually recognizable from the driver based on information related to a visual field range of the driver; and
estimating the visual field abnormality of the driver based on a driving operation of the driver in a case where the attention target is determined to be visually recognizable from the driver.
